(19) United States
(12) Patent Application Publication
(10) Pub. No.: US 2010/0250581 A1
(43) Pub. Date: Sep. 30, 2010

(54) SYSTEM AND METHOD OF DISPLAYING IMAGES BASED ON ENVIRONMENTAL CONDITIONS

(75) Inventor: Stephen Chau, Stanford, CA (US)

Correspondence Address: GOOGLE;Lerner, David, Littenberg, Krumholz & Mentlik, LLP, 600 South Avenue West, Westfield, NJ, 07090, US

(73) Assignee: Google Inc., Mountain View, CA (US)

(21) Appl. No.: 12/414,878

(22) Filed: Mar. 31, 2009

(51) Int. Cl. G06F 17/30

(52) U.S. Cl. 707/769; 707/E17.019; 707/E17.001; 707/724

(57) ABSTRACT

In one aspect, the system and method provides a modified image in response to a request for a street level image at a particular location, wherein the previously captured image is modified to illustrate the current conditions at the requested location. By way of example only, the system and method may use local weather, time of day, traffic or other information to update street level images.

### BACKGROUND OF THE INVENTION

Services such as Google Maps are capable of displaying street level images, known as “Street Views”, of geographic locations. A client computer requests a street level image from a particular location, and receives an image (often a digitized panoramic 360° photograph) in response. These images typically comprise photographs of buildings and other features taken at a time prior to the request (often by a vehicle equipped with cameras), and allow a user to view a geographic location from a person's perspective as compared to a top-down map perspective.

To aid users while viewing street level images, Google also provides image overlays on the street level image for the purpose of navigation. These overlays may include, for example, arrows that a user may click to navigate down a road to the next street level image.

A variety of websites also provide information about geographic locations. For example, the National Weather Service of the National Oceanic and Atmospheric Administration's provides the current weather conditions at various user-selectable locations. The service (e.g., http://www.weather.gov/xml/current_obs) also provides XML files containing values such as character strings that describe current weather conditions (e.g., “<weather>A Few Clouds </weather>”) at locations that may be identified by a user. The XML files also contain references to a small icon (e.g., 55×58 pixels) that is available from the site and illustrates the current weather conditions. Foe example, an icon showing a few clouds against a sunny sky may be retrieved by going to the location referenced in the XML file, such as “<icon_url_base> http://weather.gov/weather/images/fcicons/ </icon_url_base> <icon_url_name> few.jpg </icon_url_name>”).

Yet other websites provide traffic conditions (http://www.dot.ca.gov/cgi-bin/roads.cgi) and the time of day (http://www.time.gov) in response to a user identifying a location.

### BRIEF SUMMARY OF THE INVENTION

In one aspect of the invention, a method of displaying geographic objects includes: receiving a request for an image at a geographic location, the request being associated with a location; identifying, with a processor, a captured image in response to the request, wherein the captured image represents geographic objects captured by a camera and wherein the captured image is identified based on the proximity of the camera position to the location; requesting and receiving environmental condition information, wherein the environmental information comprises information identifying environmental conditions proximate to the requested location at a time after the image was captured; generating, with a processor, a second image based on the captured image and the environmental condition information such that a portion of the captured image is replaced with a representation of the environmental conditions; and providing, to an electronic display, the second image.

Another aspect also includes a method displaying geographic objects. This aspect includes: transmitting, over a network, data identifying a location; receiving, from the network, data representing an image, where a portion of the image comprises an image of the geographic objects that was taken proximate to the location, a portion of the image comprises an image representative of a weather characteristic, and the weather portion of the image was determined by querying a source of weather information with the location, and receiving information identifying a characteristic of the current weather at the location in response; and displaying the image on an electronic display.

Yet another aspect relates to a system that includes: a user input device; a memory storing instructions; a first processor in communication with the user input device so as to process information received from the user input device in accordance with the instructions; and a display in communication with, and displaying data received from, the processor. The instructions, in turn, include: providing data identifying a location; receiving and displaying image data representing a geographic object and a visual state of the geographic object, where (A) a portion of the image data comprises image data representing a geographic object at a time prior to the transmission of the data identifying the location, (B) a portion of the image comprises image data representing a visual state of the geographic object at a time after the transmission of the data identifying the location, (C) the visual state of the geographic object changes over time, and (D) a second processor processed the image data by selecting, based on the location, the image data representing a geographic object and the image data representing the visual state of the geographic object.

Still another system in accordance with another aspect of the invention includes a first computer at a first node of a network, the first computer comprising a first memory storing a first set of instructions, a first processor that processes data in accordance with the first set of instructions, and an electronic display. The system also includes a second computer at a second node of a network, the first computer comprising a second memory storing a second set of instructions and a second processor that processes data in accordance with the second set of instructions. The first set of instructions include receiving a location identified by a user, transmitting the location to the second computer over the network, receiving an image from the second computer, and displaying the image. The second set of instructions include receiving the location identified by the user, selecting a street level image from a database based on the location, retrieving a value indicative of the current environmental conditions at the location, selecting a condition-reflective image representing the environmental conditions at the location based on the value, processing the street level image and the condition-reflective image to create an image containing both the street level image and the condition-reflective image, transmitting the created image to the first computer for display on the electronic display.

### BRIEF DESCRIPTION OF THE DRAWINGS

FIG. 1 is a functional diagram of a system in accordance with an aspect of the invention.

FIG. 2 is a pictorial functional diagram of a system in accordance with an aspect of the invention.

FIG. 3 is a screen shot in accordance with an aspect of the invention.

FIG. 4 is an example of a street level image in accordance with an aspect of the invention.

FIG. 5 is an example of a modifiable portion of a street level image in accordance with an aspect of the invention.

FIG. 6 is an example of a condition-reflective image in accordance with an aspect of the invention.

FIG. 7 is a flow chart in accordance with an aspect of the invention.

FIG. 8 is a screen shot in accordance with an aspect of the invention.

FIG. 9 is a screen shot in accordance with an aspect of the invention.

FIG. 10 is an example of a modifiable portion of a street level image in accordance with an aspect of the invention.

FIG. 11 is a screen shot in accordance with an aspect of the invention.

FIG. 12 is a screen shot in accordance with an aspect of the invention.

FIG. 13 is a screen shot in accordance with an aspect of the invention.

FIG. 14 is a screen shot in accordance with an aspect of the invention.

FIG. 15 is a flow chart in accordance with an aspect of the invention.

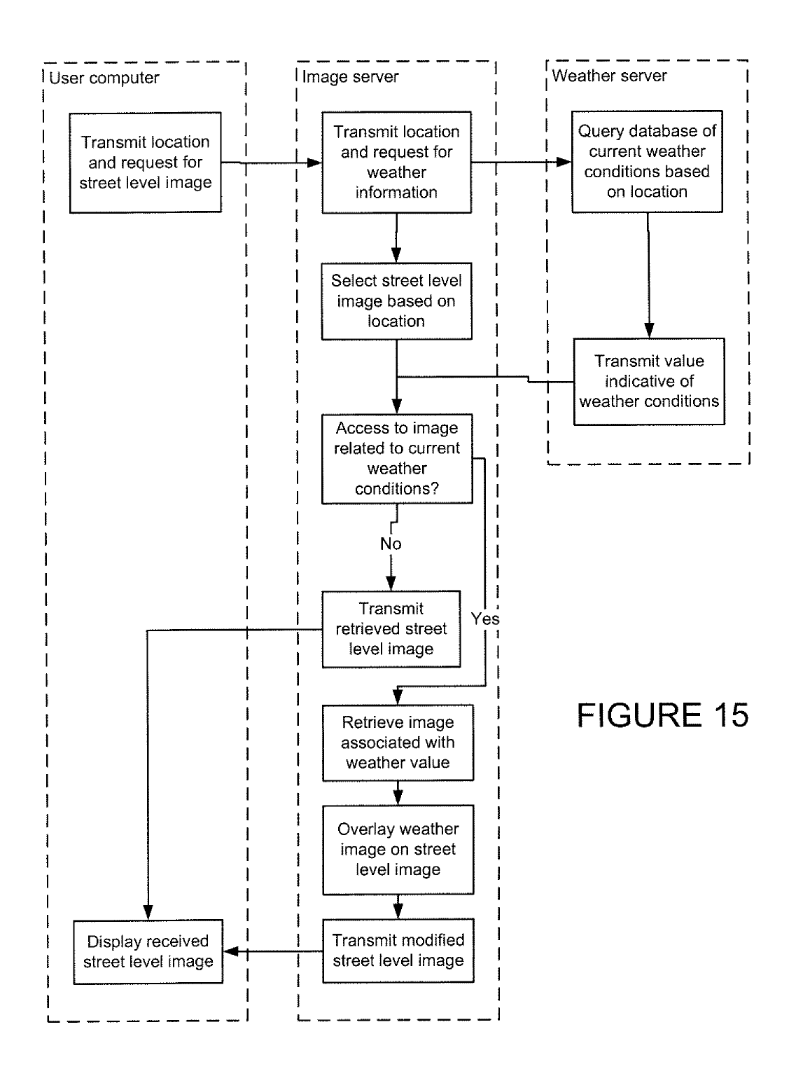

### DETAILED DESCRIPTION

In one aspect, the system and method provides a modified image in response to a request for a street level image at a particular location, wherein the previously captured image is modified to illustrate the current conditions at the requested location. By way of example only, the system and method may use local weather, time of day, traffic or other information to update street level images.

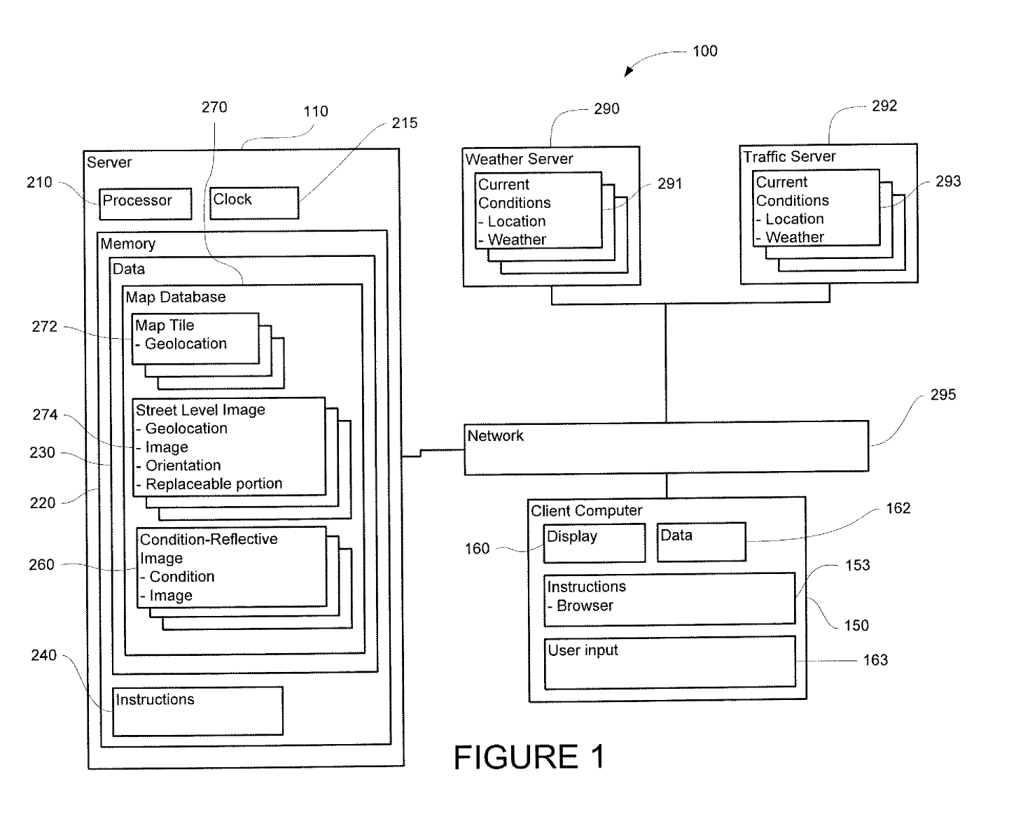

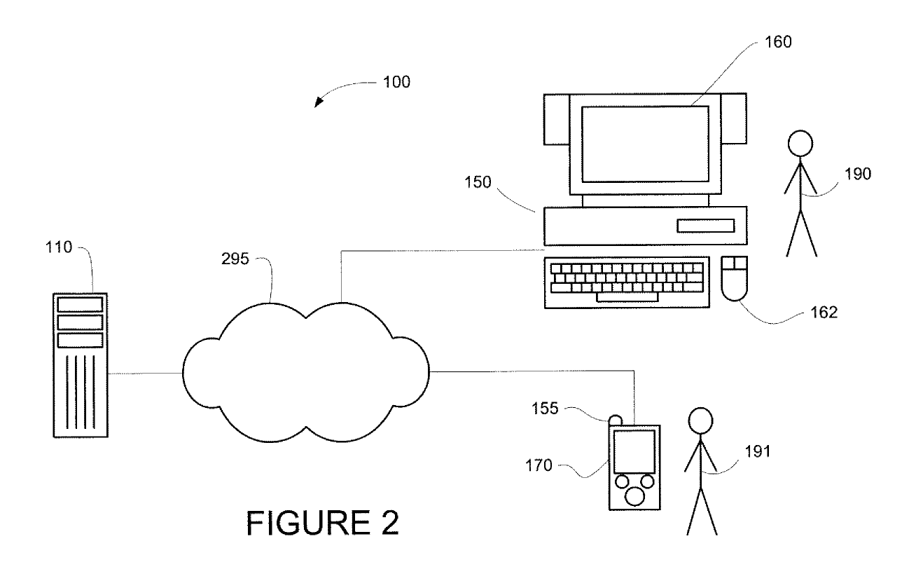

As shown in FIGS. 1-2, a system 100 in accordance with one aspect of the invention includes a computer 110 containing a processor 210, memory 220 and other components typically present in general purpose computers.

Memory 220 stores information accessible by processor 210, including instructions 240 that may be executed by the processor 210. It also includes data 230 that may be retrieved, manipulated or stored by the processor. The memory may be of any type capable of storing information accessible by the processor, such as a hard-drive, memory card, ROM, RAM, DVD, CD-ROM, write-capable and read-only memories. The processor 210 may be any well-known processor, such as processors from Intel Corporation or AMD. Alternatively, the processor may be a dedicated controller such as an ASIC.

The instructions 240 may be any set of instructions to be executed directly (such as machine code) or indirectly (such as scripts) by the processor. In that regard, the terms “instructions,” “steps” and “programs” may be used interchangeably herein. The instructions may be stored in object code form for direct processing by the processor, or in any other computer language including scripts or collections of independent source code modules that are interpreted on demand or compiled in advance. Functions, methods and routines of the instructions are explained in more detail below.

Data 230 may be retrieved, stored or modified by processor 210 in accordance with the instructions 240. For instance, although the system and method is not limited by any particular data structure, the data may be stored in computer registers, in a relational database as a table having a plurality of different fields and records, XML documents, or flat files. The data may also be formatted in any computer-readable format such as, but not limited to, binary values, ASCII or Unicode. Moreover, the data may comprise any information sufficient to identify the relevant information, such as numbers, descriptive text, proprietary codes, pointers, references to data stored in other memories (including other network locations) or information which is used by a function to calculate the relevant data.

Although the processor and memory are functionally illustrated in FIG. 1 within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

In one aspect, computer 110 is a server communicating with one or more client computers 150, 170 (only client 150 being shown in FIG. 1 for clarity). Each client computer may be configured similarly to the server 110, with a processor, memory and instructions. For example, client computer 150 may be a personal computer, intended for use by a person 190-191, having all the internal components normally found in a personal computer such as a central processing unit (CPU), display device 160 (for example, a monitor having a screen, a projector, a touch-screen, the processor, a television, a small LCD screen), CD-ROM, hard-drive, user input (for example, a mouse, keyboard, touch-screen or microphone), speakers, modem and/or network interface device (telephone, cable or otherwise) and all of the components used for connecting these elements to one another. Both server 110 and client computer 150 may include a clock, such as clock 215. Moreover, computers in accordance with the systems and methods described herein may comprise any device capable of processing instructions and transmitting data to and from humans and other computers including general purpose computers, PDAs, network computers lacking local storage capability, and set-top boxes for televisions.

Although the client computers 150 and 170 may comprise a full-sized personal computer, many aspects of the system and method are particularly advantageous when used in connection with mobile devices capable of wirelessly exchanging data with a server over a network such as the Internet. For example, client computer 170 may be a wireless-enabled PDA such as a Blackberry phone or an Internet-capable cellular phone. In either regard, the user may input information using a small keyboard (in the case of a Blackberry phone), a keypad (in the case of a typical cell phone), a touch screen (in the case of a PDA) or any other means of user input.

Client computers 150 and 170 may include a component, such as circuits, to determine the geographic location of the device. For example, mobile device 170 may include a GPS receiver 155. By way of further example, the component may include software for determining the position of the device based on other signals received at the mobile device 170, such as signals received at a cell phone's antenna from one or more cell phone towers if the mobile device is a cell phone.

The server 110 and client computers 150, 170 are capable of direct and indirect communication, such as over a network 295. Although only a few computers are depicted in FIGS. 1-2, it should be appreciated that a typical system can include a large number of connected computers, with each different computer being at a different node of the network 295. The network, and intervening nodes, may comprise various configurations and protocols including the Internet, World Wide Web, intranets, virtual private networks, wide area networks, local networks, private networks using communication protocols proprietary to one or more companies, Ethernet, WiFi and HTTP. Such communication may be facilitated by any device capable of transmitting data to and from other computers, such as modems (e.g., dial-up or cable), networks and wireless interfaces. Server 110 may be a web server.

Although certain advantages are obtained when information is transmitted or received as noted above, other aspects of the system and method are not limited to any particular manner of transmission of information. For example, in some aspects, information may be sent via a medium such as a disk, tape or CD-ROM. In other aspects, the information may be transmitted in a non-electronic format and manually entered into the system. Yet further, although some functions are indicated as taking place on a server and others on a client, various aspects of the system and method may be implemented by a single computer having a single processor.

Map database 270 of server 110 stores map-related information, at least a portion of which may be transmitted to a client device. For example, map database 270 may store map tiles 272, where each tile is a map image of a particular geographic area. Depending on the resolution (e.g., whether the map is zoomed in or out), one tile may cover an entire region, such as a state, in relatively little detail. Another tile may cover just a few streets in high detail. The map information of the system and method is not limited to any particular format. For example, the images may comprise street maps, satellite images, or a combination of these, and may be stored as vectors (particularly with respect to street maps) or bitmaps (particularly with respect to satellite images). The various map tiles are each associated with geographical locations, such that the server 110 is capable of selecting, retrieving and transmitting one or more tiles based on a receipt of a geographical location or range of geographical locations.

The map database may also store street level images 274. Street level images comprise images of objects captured by cameras at particular geographical locations in a direction roughly parallel to the ground. By way of example only, a single street level image may show a perspective view of a street and its associated buildings, taken at a position a few feet above the ground (e.g., from a camera mounted on top of a vehicle and at or below the legal limit for typical vehicles in certain states (approximately 7-14 feet)) and in a direction roughly parallel to the ground (e.g., the camera view was generally pointed down the street into the distance)). Street level images are not limited to any particular height above the ground, for example, a street level image may be taken from the top of a building.

In one aspect of the system and method, the street level images are panoramic images, such as 360° panoramas centered at the geographic location associated with the image. The panoramic street-level view image may be created by stitching together a plurality of photographs representing different camera angles taken from the same location. In other aspects, only a single street level image pointing in a particular direction may be available at any particular geographical location. The street level images are thus typically associated with both a geographical location and information indicating the orientation of the image. For example, each image may be associated with both a latitude and longitude, and data that allows one to determine which portion of the image corresponds with facing north, south, east, west, northwest, etc. Many street level images may be sized in the range of 3,000 to 13,000 pixels wide by 1,600 to 6,000 pixels high; however, unless otherwise stated, it will be understood that the system and method is not limited to images of any particular size.

Street level images may also be stored in the form of videos, such as MPEG videos captured by an analog video camera or time-sequenced photographs that were captured by a digital still camera.

In one aspect of the system and method, the images are captured by a camera prior to a request by the user for the image. For example, the image may have been captured days or longer before the request.

As discussed in more detail, the street level images 274 may also be associated with data defining a portion of the street level image, where this portion may be modified to correspond with current conditions at the location captured in the street level image.

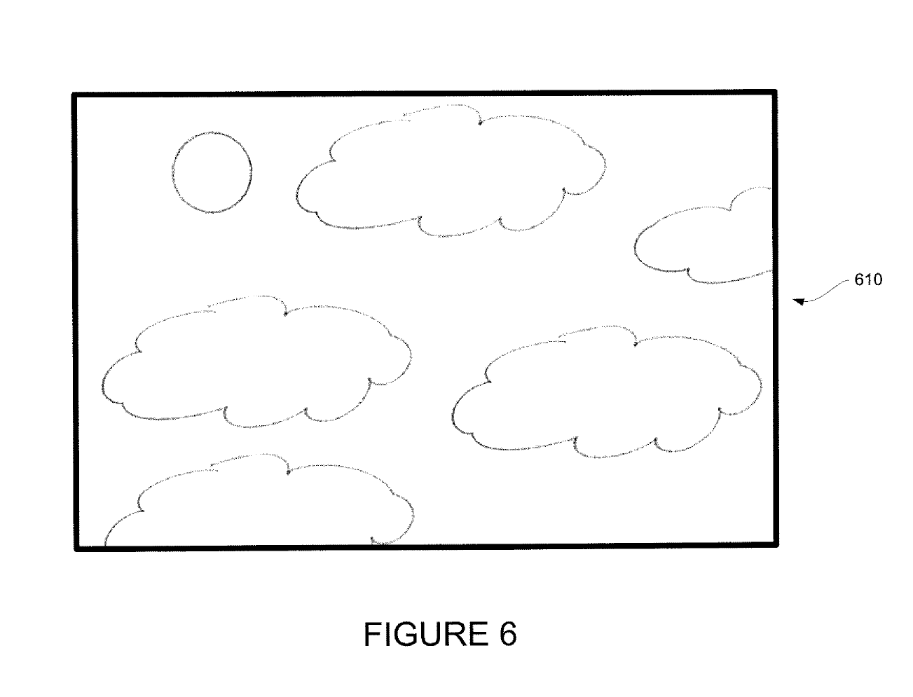

Data 230 may also include different images associated with potential environmental conditions at the locations captured in street level images. For example and as shown in FIG. 6, an image 601 of a partly cloudy sky may be associated with the condition of a partly cloudy sky. By further way of example only, the images may be associated with other weather characteristics such as precipitation (e.g., raining, snowing, hailing), cloud cover (e.g., the fraction of the sky obscured by clouds and the type of clouds) and wind (e.g., blowing leaves, bowed trees). Other states of a geographic location that are visible to people and change routinely over time may also be represented, such as traffic and the time of day. More examples of condition-reflective images 260 are discussed below.

System 100 may further include a source that provides information about the current conditions at a geographical location. These sources may be stored at the server 110 or, as shown in FIG. 1, may comprise external sources such as websites at different domains than the domain of server 110. One possible external source of information is weather server 290. In response to receiving a location over network 295, weather server 290 provides information 291 about the weather at the location. For example, weather server 290 may comprise the web server of the National Weather Service of the National Oceanic and Atmospheric Administration.

Another potential source of routinely-changing location-specific conditions comprises traffic server 292. For example, the server may track traffic at a number of different locations. When provided with a location, traffic server 292 returns a value indicative of the extent of traffic at the location.

The information provided by the servers may not precisely match conditions at the location. For example, the information stored in the servers may lag current conditions and the information may relate to locations proximate to the requested location (e.g., the nearest city with a weather station). Accordingly, and unless specifically stated to the contrary, it will be understood that references to current conditions at geographic locations actually refer to the current conditions at geographic locations as determined by the system, and not necessarily to the conditions existing at that precise current moment at that precise location.

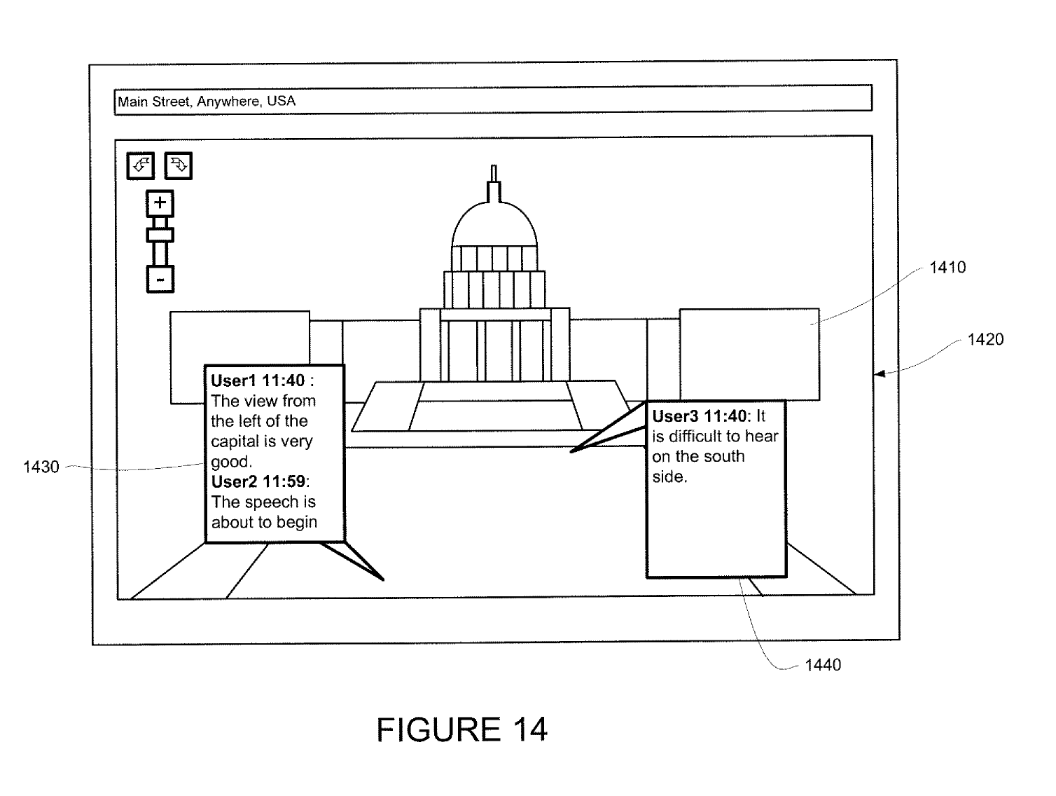

In addition to the operations illustrated in FIG. 14, various operations in accordance with a variety of aspects of the invention will now be described. It should be understood that the following operations do not have to be performed in the precise order described below. Rather, various steps can be handled in reverse order or simultaneously.

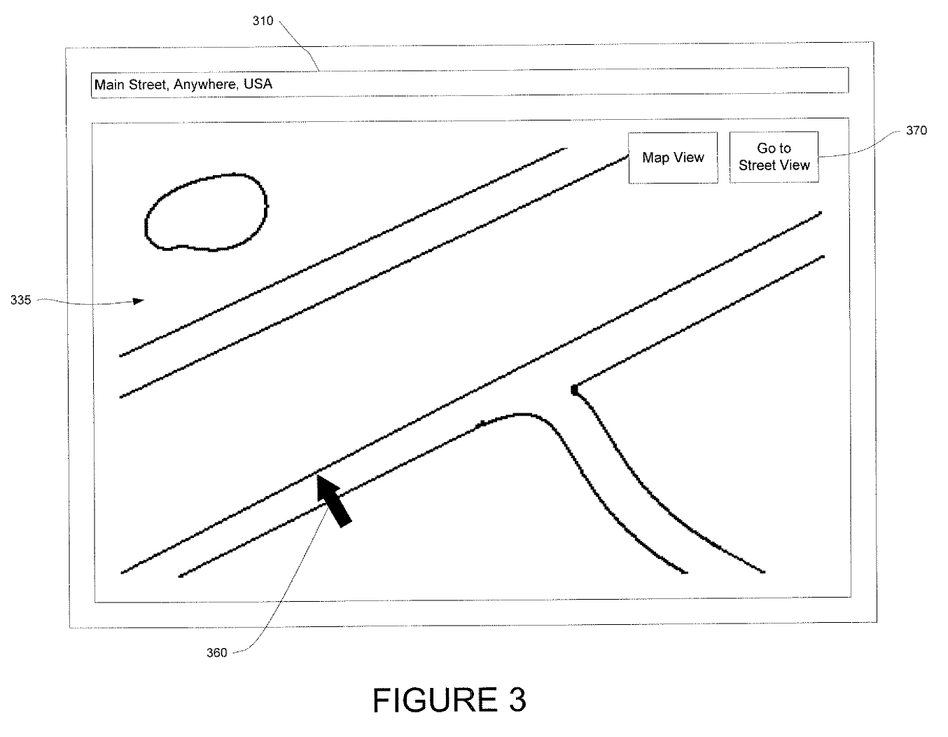

FIG. 3 illustrates a screen shot of a map from a top-down perspective that may be displayed by the display device at the client computer. For example, the system and method may be implemented in connection with an Internet browser such as Google Chrome (not shown) displaying a web page of a map 335 and other information. The program may provide the user with a great deal of flexibility when it comes to identifying a location to be shown in a street level view and requesting the street level image. For example, the user may enter information such as an address, the name of building, latitude and longitude, or some other information that identifies a particular geographical location in text box 310. The user may further use a mouse or keypad to move a cursor 360 to identify the particular geographical location of the street level image. Yet further, the program may provide a button 370 or some other feature that allows a user to request a street level view at the specified geographical location. For illustration purposes only, it will be assumed that the requested location is either expressed in, or translated into, latitude and longitude coordinates.

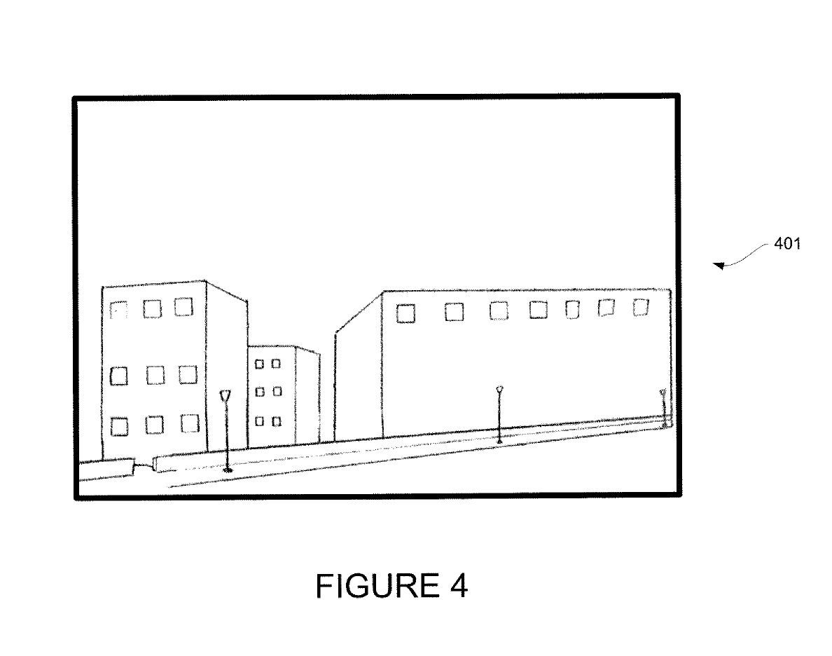

Server 110 retrieves the appropriate street level image based on the requested location. For example, if the street level images are stored based on the latitude/longitude coordinates of the camera that captured the image, the closest image to the requested latitude/longitude will be retrieved. FIG. 4 illustrates just one possible street level image 401, which represents geographic objects such as buildings, walls, streets, and lamp posts. Any other objects at geographic locations may also be represented by the image data.

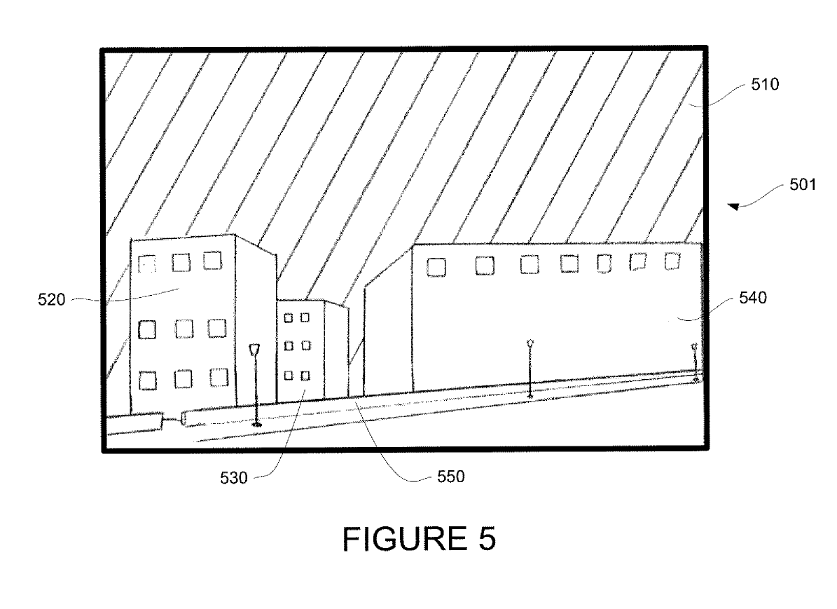

Upon identifying the location to be displayed, server 110 determines whether portions of the image should be modified to reflect current conditions at the location. For example, as shown in the street level image 501 of FIG. 5, if the portion 510 to be modified relates to the sky, the processor may attempt to identify the sky portion 501 by starting at the top-left pixel of the image and determining whether the pixels correspond with particular shades of blue and white. The processor continues to identify sky pixels by expanding down from the top of the image until it encounters non-white and non-blue edges, such as those attributable to buildings 520, 530 and 540 and wall 550. A portion of the picture associated with the sky is ultimately identified, as shown by the diagonal lines 510. This portion may also be identified prior to the user's request for a street level image at the requested location.

The system and method also retrieves information reflecting the current conditions at the requested location. For example, server 110 may determine whether there is any weather information associated with a requested latitude/longitude position by transmitting the latitude/longitude to weather server 290. Alternatively, server 270 may translate and transmit the location requested by the user into a location format used by the server. For example, the server 110 may use the latitude/longitude of the requested position to determine and transmit the name of the nearest city known to the weather server. In response, weather server 290 returns an indication of the current weather conditions at the location, such as a character string indicating “partly cloudy” or “sunny” conditions.

Server 110 also determines whether it has access to image data associated with the current condition at the location. For example, if current weather conditions indicate that the sky is partly cloudy at the requested location, server 110 queries the condition-reflective images 260 for data representing an image corresponding with the partly cloudy condition (such as a bitmap or instructions for drawing a partly cloudy sky). In response, an image of a partly cloudy image 610 such as that shown in FIG. 6 may be retrieved.

If server 110 fails to obtain access to current conditions, or lacks information enabling it modify the image to reflect current conditions, the server may simply send the street level image.

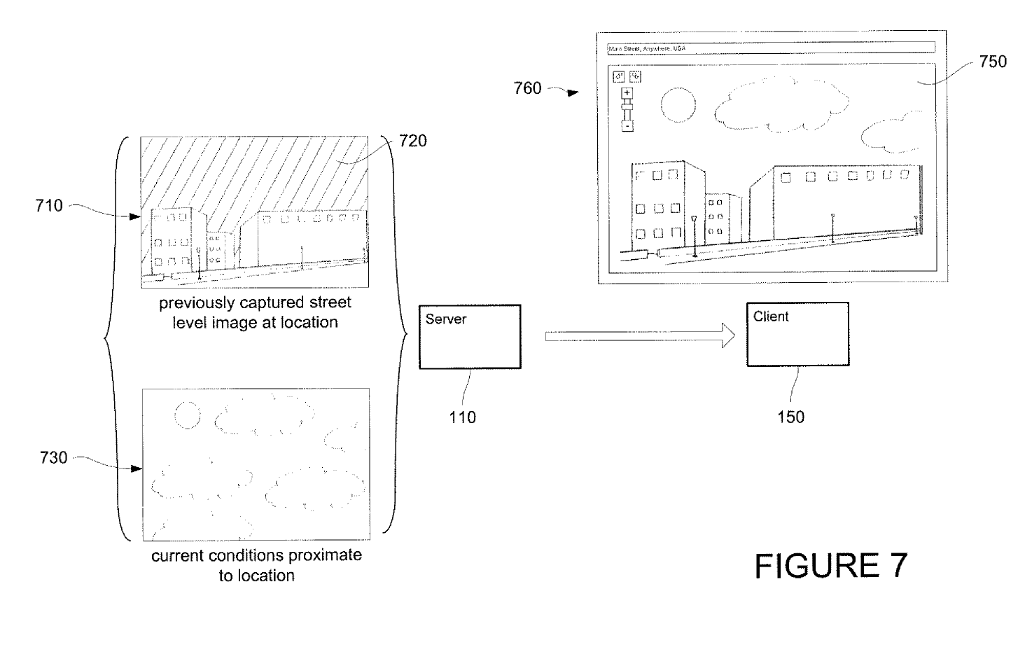

An image is then created based on both the previously-captured street level image of the requested location and the image data associated with current conditions at the requested location. For example, as shown in FIG. 7, the server 110 may create a new instance 710 of the street level image and replace the pixels 720 associated with the sky with some or all or the pixels of the condition-reflective image 730.

The resultant image 750 is transmitted to client 150 for display, such as part of a web page 760. The transmission may occur as a single bitmap prepared by the server, or as multiple images (such as multiple bitmap files) and sufficient information for the client computer to display the street level image and the condition-reflective images together. In that regard, the resultant image represents both actual objects at the location and actual weather conditions.

In one aspect of the system and method, the images of the condition-reflective images 260 are structured to create a visually pleasing image. For example, the condition-reflective images may comprise previously captured images of the sky in climates similar to the requested location rather than drawings or cartoon-style images as is common with many icons.

Moreover, the condition-reflective images may be selected or structured to correspond as much as possible with the street level images (or at least a sizeable plurality of such images). For example, the condition-reflective images may be stored in sizes that correspond with the size of the street level image in order to minimize distortion if the condition-reflective image needs to be enlarged to match the street level image, or to minimize processing time of the condition-reflective images if the condition-reflective image needs to be subsampled to match the street level image. Yet further, the condition-reflective images may be selected to correspond with the orientation of the camera angle of typical street level images. For example, condition-reflective images of skies may be selected to include sky images that were captured from a camera that is relatively close to, and oriented parallel to, the ground rather than a camera pointing straight up.

In that regard, in one aspect of the system and method, the condition-reflective images comprise images that were captured at locations unrelated to the location requested by the user. Even so, the condition-reflective images and the street level image may be combined to create the appearance that the newly added portion and previously-captured portion were captured at the same time and location.

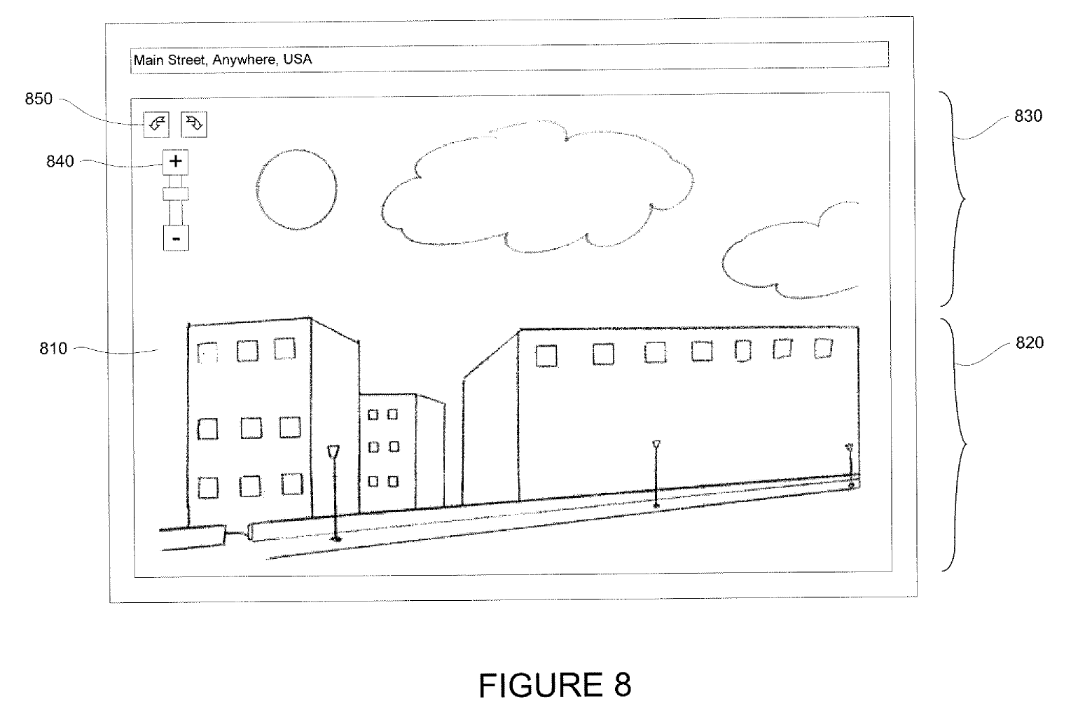

The modified street level image is then displayed on the client computer. For example, as shown in more detail in FIG. 8, instead of simply displaying the street level image stored in the map database, the client computer displays a street level image 810 including the previously-captured portion 820 and a portion 830 reflecting current conditions at the location.

If the weather had been completely overcast, a condition-reflective image corresponding with overcast skies would have been used instead. The result would be a street level image showing an overcast sky even if the street level image stored in the map database captured a clear sunny sky.

The street level image 810 may be shown in the browser along with controls 840 for zooming the image and controls 850 for changing the orientation of the view (which may require another street level image being retrieved and modified with a condition-reflective image). Other navigation controls may be included as well, such as panning controls in the form of arrows disposed along the street. Such arrows may be selected by a user (by clicking or by dragging along the street line) to change the vantage point from up or down the street.

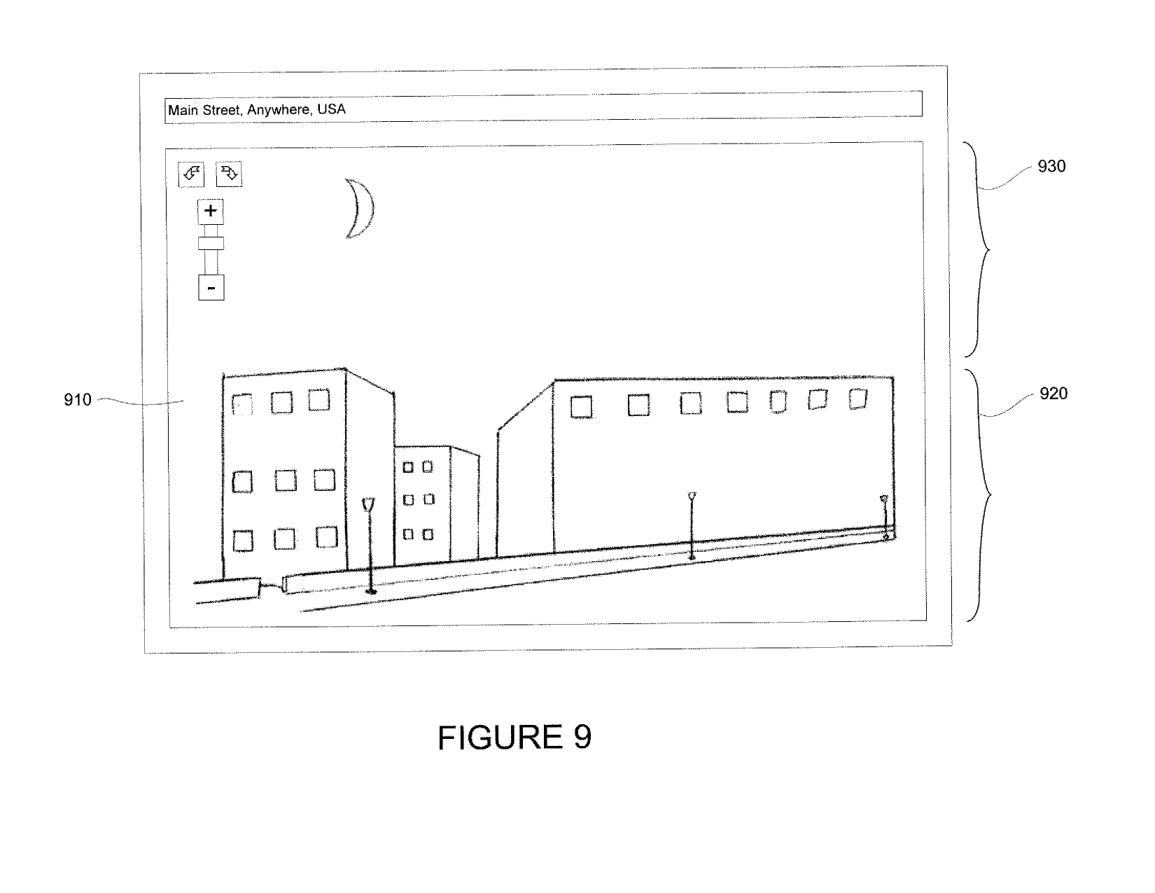

Although modifying previously-captured images with images associated with current weather conditions has particular advantages, the system and method allows for modification based on other types of data as well. For example, the sky of the street level image may be modified to reflect the time of day at the requested location. As shown in FIG. 9, the browser may display a night sky portion 930 that is superimposed on the previously captured portion 920 street level image 910. The time of the day at the requested location may be determined by using the latitude/longitude of the requested location to determine the location's time zone. The time zone, in turn, may be used along with the server's own clock 215 to determine the current time at the location. Yet further, the calculated time at the location may be used by a processor to select and display a condition-reflective image of the sky at dawn, morning, afternoon, dusk, or night.

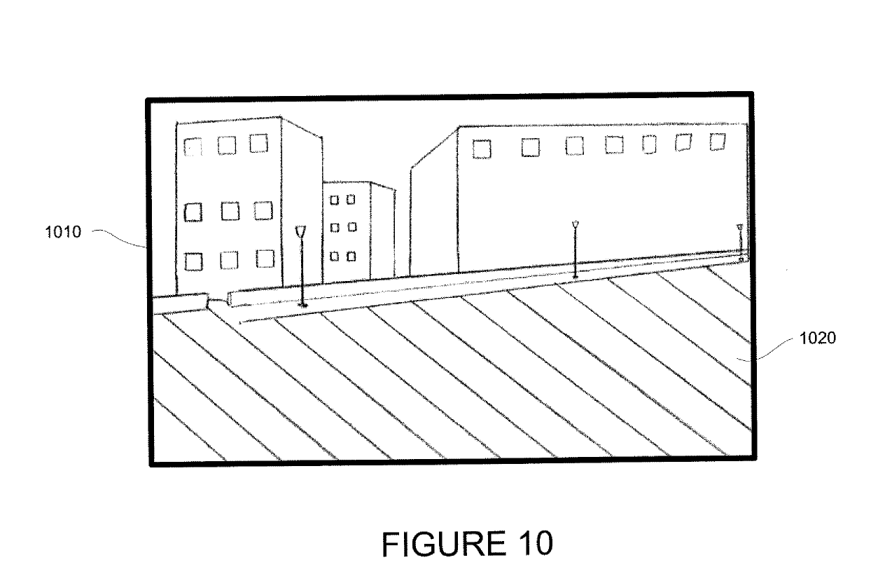

The system and method also allows for modification of other portions of the image. For example, as shown in FIG. 10, the street portion 1020 (indicated by diagonal lines) of the previously-captured street level image 1010 may be modified.

The system and method may modify the street level image so that the amount of vehicles shown on the image's streets reflect the current traffic conditions of that street. When the desired location is received, server 110 may determine the name of the street(s) captured in the image (such as by using a geocoder on the latitude/longitude position of the street level image). The server may then use the name of the street to query traffic server 292 (FIG. 1) for information relating to the amount of traffic on the street.

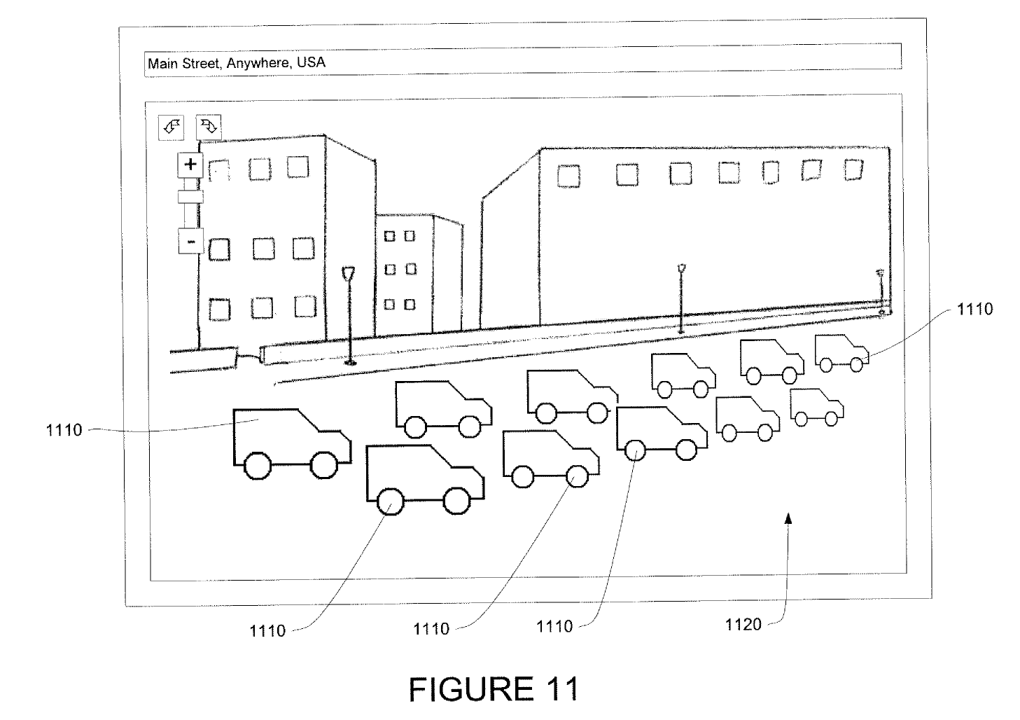

In one aspect of showing traffic, the server retrieves an image of a car. As shown in FIG. 11, if the traffic server provides a value indicating that there is a great deal of traffic, that same image 1110 may be superimposed many times on the street 1120, and at many different locations, to convey the impression of a great deal of traffic.

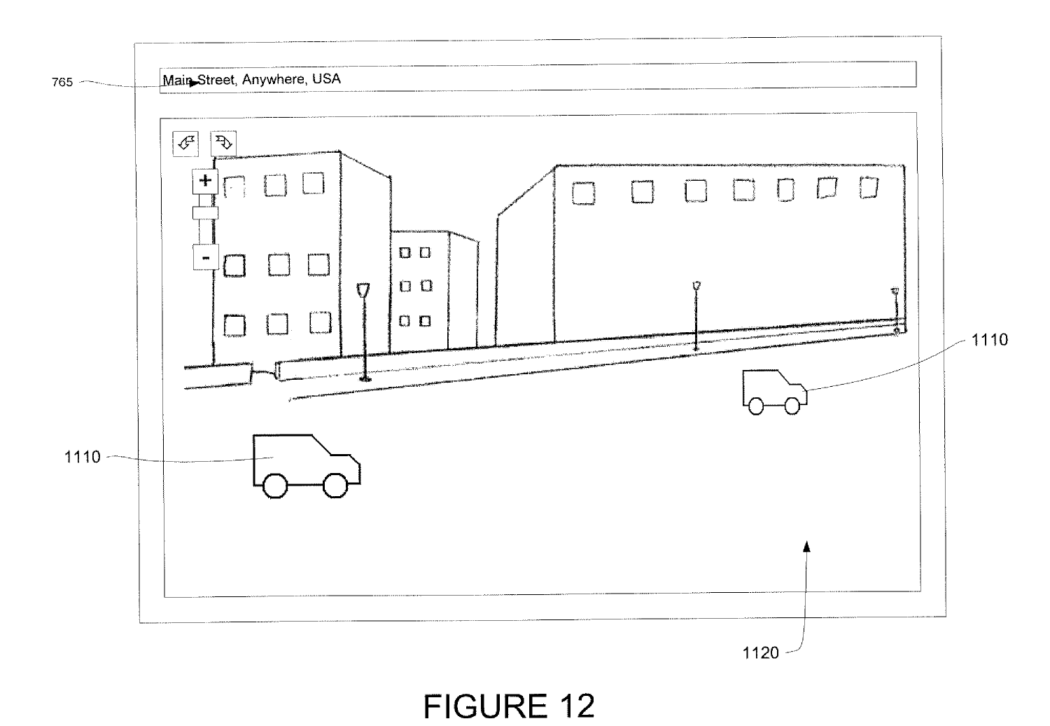

As shown in FIG. 12, if the traffic server indicates relatively little traffic, the image may be modified to show relatively little traffic on the street, such as by superimposing relatively few vehicle images 1110 on the street 1120.

In other aspects of the system and method, the server compares the previously-captured image with the current conditions and only modifies the image if the conditions do not match. For example, in response to a request from a user for a street level image of a particular street, a processor may retrieve the currently-stored street level image and use image processing (e.g., pattern recognition) to determine the approximate number of vehicles on the street. This information, in turn, is used to obtain a value indicative of the amount traffic shown in the picture. The processor also obtains a value, from a source of traffic data, associated with the current amount of traffic on the street.

If the traffic value of the image is less than the source's traffic value, photo-realistic images of cars may be superimposed on those portions of the street lacking a car. These images may be obtained from the map database or by replicating images of cars in the image being analyzed. If the traffic value of the image is more than the source's traffic value, the processor may replace images of the cars with images of pavement (such as by replicating images of pavement in the image being analyzed). Regardless of the source of the condition-reflective images, the images may be sized and oriented to provide as much realism as possible.

In lieu of showing traffic, the street level image may also be modified to show additional information about current road conditions such as by adding traffic cones or road closure signs to the street if the street is closed.

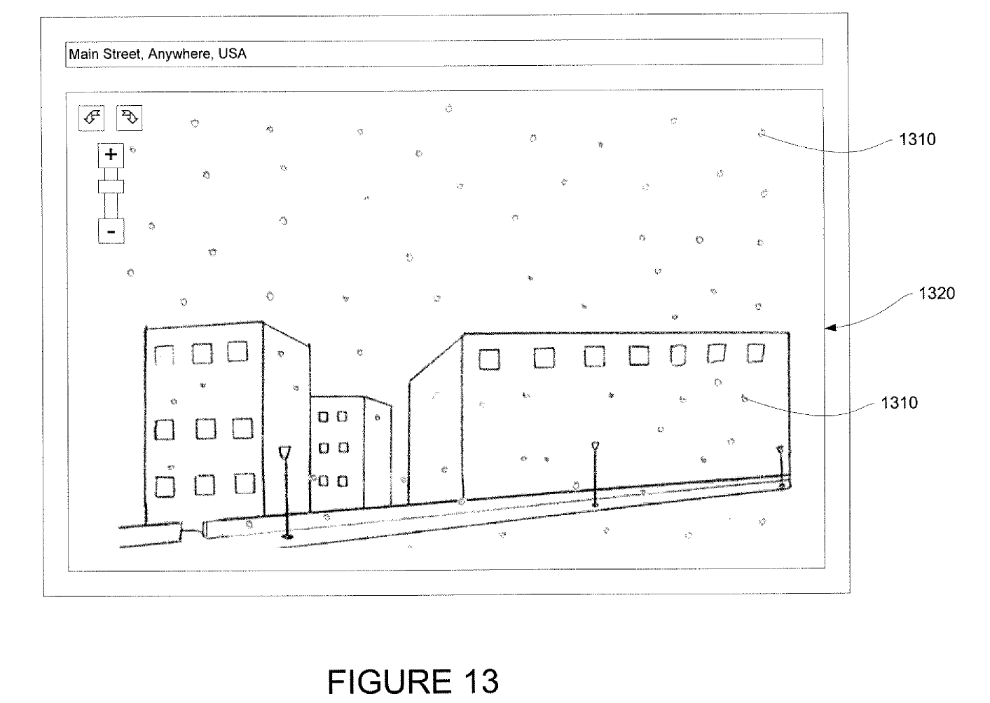

Other aspects of the system and method do not identify particular areas of the street level image to be modified. For example, as shown in FIG. 13, images of snow flakes 1310 may be retrieved and overlaid across the entire street level image 1320 if the weather server indicates that snow is falling at the requested location.

In one alternative aspect, the system and method displays information that (1) would not have been captured by the camera that captured the street level image but (2) is associated with the location. FIG. 14 illustrates just one possibility, where a captured image of the U.S. Capital Building 1410 is represented in the street level image 1420 and displayed on a screen to a user. The processor may also display, over a portion of the street level image, a text box 1430 that contains information provided by people at the location after the image was taken and relatively just prior to the request for the image. For example, a user may read live descriptions at a presidential inauguration as it occurs while simultaneously viewing an image of the Capital that was selected as described above. The text may be obtained in any number of ways, such as by downloading text from a server that receives text from people at the location. For instance, people at the location may upload live descriptions of the event and their location via their cell phones to a server such as those used by the Twitter service or Google Groups. When the street level image 1410 is requested and displayed, this same server may be queried for live information associated with the location and the results of the query in text boxes 1430 and 1440. As shown in FIG. 14, multiple descriptions of the event may be displayed at the locations from which the information was received, such as locations to the left and right of the building.

Yet other aspects of the system and method incorporate combinations of conditions at the requested location. By way of example, if the user requests a street level image of a location, and if the conditions at the location indicate that it is night-time with cloudy skies and relatively little traffic, and processor may take the existing image and replace a clear daytime sky with a cloudy nighttime sky and remove images of cars from a busy street.

In another aspect of the system and method, the server 110 periodically downloads and caches conditions at various locations, and uses the cached information to modify the requested image.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention should not be interpreted as limiting the invention to the specific examples; rather, the examples are intended to illustrate only one of many possible embodiments.

1. A method of displaying images comprising:
receiving a request for an image at a geographic location, the request being associated with a location;
identifying, with a processor, a captured image in response to the request, wherein the captured image represents geographic objects captured by a camera and wherein the captured image is identified based on the proximity of the camera position to the location;
requesting and receiving environmental condition information, wherein the environmental information comprises information identifying environmental conditions proximate to the requested location at a time after the image was captured;
generating, with a processor, a second image based on the captured image and the environmental condition information such that a portion of the captured image is replaced with a representation of the environmental conditions; and
providing, to an electronic display, the second image.

2. The method of claim 1 wherein the environmental condition information comprises information representing the weather at the requested location at a time after the environmental condition information was requested and before it was received.

3. The method of claim 2 wherein the environmental condition information comprises information representing precipitation.

4. The method of claim 1 wherein the environmental condition information comprises information representing the traffic at the requested location at a time after the environmental condition information was requested and before it was received.

5. The method of claim 1 wherein the environmental condition information comprises information representing the time of day at the requested location at a time after the environmental condition information was requested and before it was received.

6. The method of claim 1 wherein the environmental condition information represents an image of the environmental conditions.

7. The method of claim 6 wherein the environmental condition information is an image of a sky.

8. The method of claim 6 wherein providing the captured image and information associated with environmental conditions comprises creating an image wherein a first portion comprises at least a portion of the captured image and a second portion comprises the image of the environmental conditions.

9. The method of claim 1 wherein the second image is provided by a server at a node of a network to an electronic display at another node of a network.

10. The method of claim 1 wherein the second image is generated at a computer and the method further comprises displaying the second image on an electronic display connected to the computer.

11. A method of displaying a geographic object:
transmitting, over a network, data identifying a location;
receiving, from the network, data representing an image, where:
a portion of the image comprises an image of the geographic objects that was taken proximate to the location,
a portion of the image comprises an image representative of a weather characteristic, and
the weather portion of the image was determined by querying a source of weather information with the location, and receiving information identifying a characteristic of the current weather at the location in response; and
displaying the image on an electronic display.

12. The method of claim 11 wherein the weather portion was determined by selecting an image of a weather characteristic based on the information received from source of weather information, and displaying the image comprises displaying the selected image of a weather characteristic.

13. The method of claim 11 wherein the weather characteristic is a type of cloud cover, the weather portion of the image comprises an image of a sky corresponding with the type of cloud cover, and the weather portion of the image is displayed in place of the image of the sky that was captured when the image of the geographic objects was taken.

14. The method of claim 11 wherein the weather characteristic indicates the state of precipitation at the location, and wherein displaying the image comprises displaying precipitation superimposed on the image of the geographic objects if the information received from the weather source indicates that there is currently precipitation at the location.

15. A system comprising:
a user input device;
a memory storing instructions;
a first processor in communication with the user input device so as to process information received from the user input device in accordance with the instructions; and
a display in communication with, and displaying data received from, the processor;
the instructions comprising:
providing data identifying a location;
receiving and displaying image data representing a geographic object and a visual state of the geographic object, where (A) a portion of the image data comprises image data representing a geographic object at a time prior to the transmission of the data identifying the location, (B) a portion of the image comprises image data representing a visual state of the geographic object at a time after the transmission of the data identifying the location, (C) the visual state of the geographic object changes over time, and (D) a second processor processed the image data by selecting, based on the location, the image data representing a geographic object and the image data representing the visual state of the geographic object.

16. The system of claim 15 further comprising a server, wherein the server provides data representing a visual state of the geographic object in response to receiving data representing a geographic location.

17. The system of claim 15 wherein the visual state of the geographic object comprises the weather conditions at the geographic object.

18. The system of claim 17 wherein the weather condition comprises cloud cover.

19. The system of claim 17 wherein the visual state of the geographic object comprises precipitation.

20. The system of claim 15 wherein the visual state of the geographic object is determined by querying a database with the location so as to obtain a value indicative of the visual state.

21. The system of claim 15 wherein the visual state of the geographic object comprises the time of day at the geographic object.

22. The system of claim 15 wherein the geographic object comprises a street and the visual state of the geographic object comprises traffic on the street.

23. The system of claim 15 wherein the image data representing a geographic object at a time prior to the transmission of the data identifying the location comprises a photograph of the geographic object.

24. The system of claim 15 wherein the geographic object is a building.

25. A system of displaying images comprising:
a first computer at a first node of a network, the first computer comprising a first memory storing a first set of instructions, a first processor that processes data in accordance with the first set of instructions, and an electronic display,
a second computer at a second node of a network, the second computer comprising a second memory storing a second set of instructions and a second processor that processes data in accordance with the second set of instructions,
said first set of instructions comprising receiving a location identified by a user, transmitting the location to the second computer over the network, receiving an image from the second computer, and displaying the image,
said second set of instructions comprising receiving the location identified by the user, selecting a street level image from a database based on the location, retrieving a value indicative of the current environmental conditions at the location, selecting a condition-reflective image representing the environmental conditions at the location based on the value, processing the street level image and the condition-reflective image to create an image containing both the street level image and the condition-reflective image, transmitting the created image to the first computer for display on the electronic display.

26. The system of claim 25 wherein the condition-reflective image represents weather at the location.

27. The system of claim 26 wherein the condition-reflective image represents precipitation at the location.

28. The system of claim 26 wherein the condition-reflective image represents cloud cover at the location.

29. The system of claim 25 wherein the condition-reflective image represents the time of day at the location.

30. The system of claim 25 wherein the condition-reflective image represents traffic at the location.

31. The system of claim 30 wherein the condition-reflective image is an image of a vehicle, and wherein processing the street level image and the condition-reflective image comprises overlaying a plurality of images of vehicles on a street captured in the street level image.
